(19) United States
(12) Patent Application Publication
(10) Pub. No.: US 2026/0016400 A1
(43) Pub. Date: Jan. 15, 2026

(54) MEASUREMENT DEVICE AND MEASUREMENT METHOD

(71) Applicant: Tokyo Seimitsu Co., Ltd., Tokyo (JP)

(72) Inventor: Naoki MIYAZAKI, Tsuchiura-city (JP)

(73) Assignee: Tokyo Seimitsu Co., Ltd., Tokyo (JP)

(21) Appl. No.: 19/332,890

(22) Filed: Sep. 18, 2025

Related U.S. Application Data
(63) Continuation of application No. PCT/JP2024/009738, filed on Mar. 13, 2024.

(30) Foreign Application Priority Data
Mar. 22, 2023 (JP) 2023-045527

(51) Int. Cl. G01N 21/31

(52) U.S. Cl. CPC G01N 21/31

(57) ABSTRACT

A measurement device includes: a light source that emits multi-wavelength light; a first optical unit that introduces chromatic aberration into the multi-wavelength light along an optical axis; a second optical unit that focuses the multi-wavelength light into which the chromatic aberration has been introduced onto a measurement position of a measurement object; at least one dimming member that blocks a part of the multi-wavelength light incident on the first optical unit and that is arranged at a position intersecting the optical axis; a dimming adjustment unit that varies an area of the multi-wavelength light blocked by the at least one dimming member; an aperture portion that allows at least a part of the multi-wavelength light that has passed through the at least one dimming member, to pass therethrough; and a light receiver unit that acquires spectral information of the multi-wavelength light that has passed through the aperture portion.

### CROSS-REFERENCE TO RELATED APPLICATIONS

The present application is a Continuation of PCT International Application No. PCT/JP2024/009738 filed on Mar. 13, 2024 claiming priority under 35 U.S.C § 119 (a) to Japanese Patent Application No. 2023-045527 filed on Mar. 22, 2023. Each of the above applications is hereby expressly incorporated by reference, in its entirety, into the present application.

### BACKGROUND OF THE INVENTION

### Field of the Invention

The present invention relates to a measurement device and a measurement method.

### Description of the Related Art

Conventionally, measurement devices that measure surface properties (surface conditions) of a measurement object using a color confocal method have been known. The color confocal method is a measurement principle using chromatic aberration along the optical axis of refraction optical systems. In the optical system where chromatic aberration occurs, a focusing distance varies depending on the wavelength.

When measuring the surface of a measurement object, multi-wavelength light containing a plurality of wavelengths different from each other is output from a controller, and the multi-wavelength light is irradiated to the measurement object through an optical fiber and a probe.

Due to chromatic aberration, the multi-wavelength light emitted from the probe focuses on positions different for each wavelength on the optical axis. The controller includes a spectrometer, which detects a light having a wavelength that has focused on the surface of the measurement object, out of the reflected lights of the multi-wavelength light irradiated to the measurement object. The wavelength of the light detected by the spectrometer is converted into the distance. In this way, non-contact distance measurement is implemented.

Patent Literature 1 describes a confocal measurement device that uses the color confocal method to measure a measurement object. A confocal optical system described in Patent Literature 1 includes a light shielding member that blocks unnecessary lights passing through a center portion of a diffraction lens so as to reduce crosstalk.

### CITATION LIST

### Patent Literature(s)

Patent Literature 1: International Publication No. 2020/059677

### SUMMARY OF THE INVENTION

However, when the light shielding member is arranged on the optical path as in the device described in Patent Literature 1, the total amount of reflected lights from the measurement object decreases. The decrease in the total amount of reflected light may cause deterioration in measurement accuracy due to deterioration in accuracy of peak detection. When a material with relatively low reflectivity is used for the measurement object in particular, the peak detection itself becomes difficult.

The present invention has been made in view of such circumstances, and the present invention aims to provide a measurement device and a measurement method, capable of restraining the incidence of unnecessary reflected light in the color confocal method and securing a light amount of the reflected light required for peak detection.

In order to accomplish the above object, following aspects of the invention are provided.

A measurement device according to a first aspect of the present disclosure includes: a light source configured to emit multi-wavelength light containing a plurality of light components having wavelengths different from each other; a first optical unit configured to introduce chromatic aberration along an optical axis into the multi-wavelength light emitted from the light source; a second optical unit configured to focus the multi-wavelength light, into which the chromatic aberration has been introduced, onto a measurement position of a measurement object; at least one dimming member configured to block a part of the multi-wavelength light incident on the first optical unit, the at least one dimming member arranged at a position intersecting the optical axis; a dimming adjustment unit configured to vary an area ratio that is a ratio of an area of the multi-wavelength light blocked by the at least one dimming member to a cross-sectional area of the multi-wavelength light at the position where the at least one dimming member is arranged; an aperture portion configured to allow at least a part of the multi-wavelength light that has passed through the at least one dimming member, to pass therethrough; and a light receiver unit configured to acquire spectral information of the multi-wavelength light which has passed through the aperture portion.

In the measurement device according to the first aspect of the present disclosure, the dimming member that blocks a part of the multi-wavelength light incident on the first optical unit and that is arranged at the position penetrated by the optical axis, can vary the area ratio that is a ratio of the area of the multi-wavelength light blocked by the dimming member to the cross-sectional area of the multi-wavelength light at the position where the dimming member is arranged. As a result, the reflected light that is reflected without focusing on the measurement position of the measurement object is suppressed from being incident on the light receiver unit, and the amount of reflected light required for peak detection is secured.

A third optical unit may be provided to guide the multi-wavelength light emitted from the light source toward the first optical unit. The third optical unit may include a collimator lens that generates collimated light directed to the first optical unit.

Examples of the multi-wavelength light that has passed through the dimming member may include multi-wavelength light that has passed through the position of the dimming member in an optical axis direction without being blocked by the dimming member.

The aperture portion may be arranged at a position that has a conjugate relationship with a focus position of the multi-wavelength light on the measurement object.

According to a second aspect, in the measuring device according to the first aspect, the dimming adjustment unit may include a position adjustment unit configured to adjust a position of the at least one dimming member in a direction parallel to the optical axis.

In the second aspect, depending on the position of the dimming member in the direction parallel to the optical axis, the area ratio can be varied, the area ratio being a ratio of the area of the reflected light blocked by the dimming member to the cross-sectional area of the reflected light at the position where the dimming member is arranged.

According to a third aspect, the measurement device of the second aspect may include a plurality of dimming members, and the position adjustment unit may include a selection unit configured to select the dimming member to be arranged at a position that blocks the multi-wavelength light, from among the plurality of dimming members supported at different positions from each other, along the direction parallel to the optical axis.

In the third aspect, the dimming members can be arranged at a plurality of prescribed positions in the direction parallel to the optical axis.

According to a fourth aspect, in the measurement device according to the second aspect, the position adjustment unit may include a movement unit configured to move the at least one dimming member in the direction parallel to the optical axis.

In the fourth aspect, the dimming member may be arranged at any position in the direction parallel to the optical axis.

According to a fifth aspect, in the measurement device according to any one of the first to fourth aspects, the at least one dimming member may be arranged between the first optical unit or the second optical unit, and the aperture portion.

In the fifth aspect, the dimming member may be arranged on an optical path where a beam diameter of the reflected light varies.

According to a sixth aspect, in the measurement device according to any one of the first to fifth aspects, the dimming adjustment unit may include a size variable unit configured to vary the area of the at least one dimming member that blocks the multi-wavelength light.

In the sixth aspect, it is possible to achieve blocking the multi-wavelength light in accordance with the size of the dimming member.

According to a seventh aspect, the measurement device according to any one of the first to sixth aspects may include a measurement condition acquisition unit configured to acquire a measurement condition in measuring the measurement object, and depending on the acquired measurement condition, the dimming adjustment unit may vary an area ratio that is a ratio of the area of the multi-wavelength light blocked by the at least one dimming member to the cross-sectional area of the multi-wavelength light at the position where the at least one dimming member is arranged.

In the seventh aspect, it is possible to achieve preferable peak detection of the reflected light according to the measurement condition.

According to an eighth aspect, the measurement device according to any one of the first to seventh aspects may include a probe configured to irradiate the multi-wavelength light into which the chromatic aberration has been introduced, onto the measurement position of the measurement object, and to receive reflected light of the multi-wavelength light irradiated onto the measurement object, and the probe includes the first optical unit, the second optical unit, and the at least one dimming member.

According to the eighth aspect, it is possible to dim the reflected light that is unnecessary for peak detection in the reflected light, in the probe that irradiates the multi-wavelength light to the measurement position of the measurement object and that receives the reflected light.

According to a ninth aspect, in the measurement device according to any one of the first to eighth aspects, the first optical unit and the second optical unit may be configured integrally.

A measurement method according to the present disclosure is a measurement method for measuring a surface of a measurement object by irradiating to the measurement object, multi-wavelength light which contains a plurality of light components having wavelengths different from each other and into which chromatic aberration is introduced along an optical axis, the measurement method including: focusing the multi-wavelength light into which the chromatic aberration is introduced, onto a measurement position of the measurement object; varying an area ratio, the area ration being a ratio of an area of the multi-wavelength light blocked by at least one dimming member to a cross-sectional area of the multi-wavelength light at a position where the at least one dimming member is arranged, wherein the at least one dimming member is arranged at a position intersecting the optical axis and blocks a part of the multi-wavelength light incident on a first optical unit that has introduced the chromatic aberration; allowing at least a part of the multi-wavelength light that has passed through the at least one dimming member to pass through an aperture portion having a conjugate relationship with a focus position on the measurement object; and acquiring spectral information of the multi-wavelength light which has passed through the aperture portion.

The measurement method according to the present disclosure may achieve similar operational effects as those of the measurement device according to the present disclosure. The features of measurement devices according to other aspects are applicable to the features of the measurement method according to other aspects.

According to the present invention, the dimming member that blocks a part of the reflected light reflected by the measurement object and that is arranged at the position intersecting the optical axis, may vary an area ratio, the area ratio being a ratio of the area of the reflected light blocked by the dimming member to the cross-sectional area of the reflected light at the position where the dimming member is arranged. As a result, the reflected light that is reflected without focusing on the measurement position of the measurement object is suppressed from being incident on a spectrometer, and the amount of reflected light required for peak detection is secured.

### BRIEF DESCRIPTION OF THE DRAWINGS

FIG. 1 is an overall configuration diagram showing a configuration example of a measurement device according to a first embodiment.

FIG. 2 is a schematic diagram of optical paths of incident light.

FIG. 3 is a schematic diagram of optical paths of reflected light.

FIG. 4 is an explanatory diagram of a color confocal method and is also an explanatory diagram regarding the generation of chromatic aberration.

FIG. 5 is a schematic diagram showing an output signal of a spectrometer corresponding to the reflected light that has passed through a peripheral portion of an objective lens.

FIG. 6 is an explanatory diagram regarding the issues of the color confocal method and is also a schematic diagram of the light that has passed through a center portion of the objective lens.

FIG. 7 is a schematic diagram showing an output signal of the spectrometer corresponding to the reflected light that has passed through a center portion of the lens.

FIG. 8 is a schematic diagram of an output signal actually observed.

FIG. 9 is a schematic diagram showing a configuration example of a probe applied to the measurement device according to the first embodiment.

FIG. 10 is a functional block diagram showing an electrical configuration of the measurement device according to the first embodiment.

FIG. 11 is a flowchart showing a procedure of a measurement method according to the first embodiment.

FIG. 12 is a schematic diagram showing a configuration example of a probe applied to a measurement device according to a second embodiment.

FIG. 13 is a functional block diagram showing an electrical configuration of the measurement device according to the second embodiment.

FIG. 14 is a schematic diagram showing a configuration example of a probe applied to a modification.

FIG. 15 is a front view of a dimming member showing an example of the size of the dimming member.

FIG. 16 is a functional block diagram showing an electrical configuration of a measurement device according to a third embodiment.

FIG. 17 is a flowchart showing a procedure of a measurement method according to the third embodiment.

### DESCRIPTION OF THE EMBODIMENTS

Hereinafter, preferable embodiments of the present invention are described in detail with reference to the accompanying drawings. In this specification, identical elements are designated by identical reference numerals, and redundant descriptions are omitted where appropriate.

### [Overall Configuration of Measurement Device According to First Embodiment]

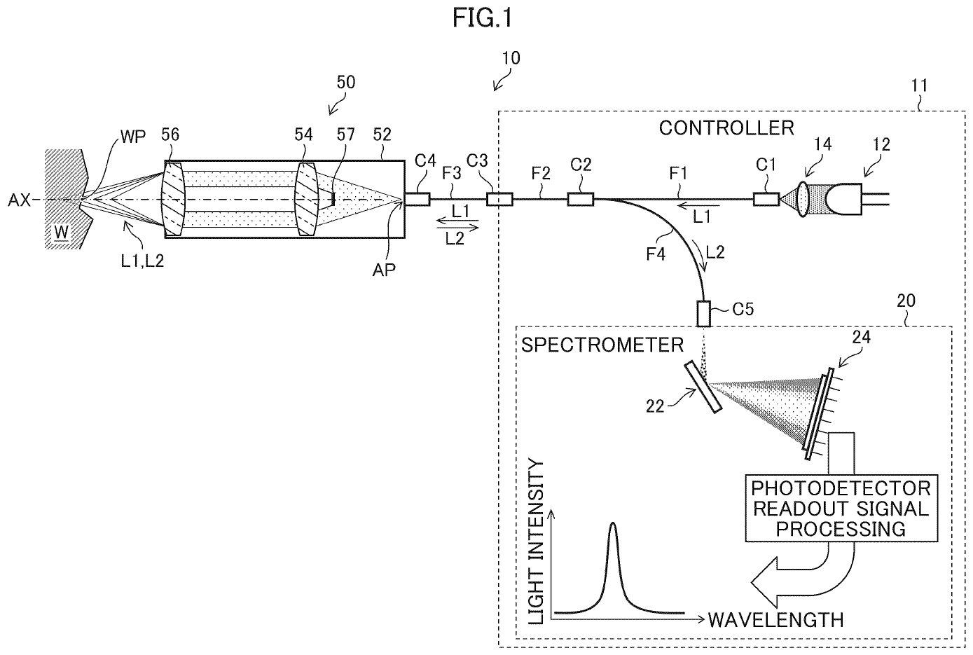

FIG. 1 is an overall configuration diagram showing a configuration example of a measurement device according to a first embodiment. A measurement device 10 shown in FIG. 1 uses a color confocal method, to which a measurement principle using axial chromatic aberration in refractive optical systems is applied. The axial chromatic aberration refers to chromatic aberration generated along the optical axis. In optical systems where chromatic aberration is generated, a focusing distance varies for each wavelength, and most portions of a reflected light that are focused on a measurement position WP of a measurement object W return to an optical fiber F3. Using a spectrometer 20, the reflected light focused on the measurement position WP of the object W is read, and the wavelength of the reflected lights is converted to the distance. In this way, the distance between the probe 50 and the measurement position WP of the measurement object W is derived, and non-contact measurement of the measurement object W is implemented.

The measurement device 10 includes a controller 11. The controller 11 includes a light source 12, a light guide member 14, an optical connector C1, an optical fiber F1, an optical splitter C2, an optical fiber F2, an optical connector C3, an optical fiber F4, and an optical connector C5.

The light source 12 is a light source that emits a multi-wavelength light L1 containing a plurality of wavelengths different from each other. Examples of light-emitting elements applied to the light source 12 may include light-emitting diodes, laser diodes, and halogen lamps. The light-emitting diodes may be referred to as LED, which is an abbreviation for Light-Emitting diode. Examples of the multi-wavelength light L1 may include broadband light and white light. The wavelength may include the concept of the color of the chromatic aberration described above.

The light guide member 14 condenses (focuses) the light emitted from the light source 12 to the optical connector C1, which is a light input port of the optical fiber F1. FIG. 1 schematically illustrates one lens as the light guide member 14, though the light guide member 14 may include a plurality of optical elements, such as lenses.

The optical connector C1 functions as one end of the optical fiber F1. The optical fiber F1 is connected to one end of the optical fiber F2 and one end of the optical fiber F4 through the optical splitter C2. The other end of the optical fiber F2 is connected to the optical connector C3.

The optical splitter C2 has a merge port that is connected to the optical fiber F2. The optical splitter C2 has a first branch port that is connected to the other end of the optical fiber F1. The optical splitter C2 has a second branch port that is connected to one end of the optical fiber F4. The other end of the optical fiber F4 is connected to the optical connector C5. Examples of the optical splitter C2 may include optical couplers, splitters, and optical circulators.

The controller 11 includes the spectrometer 20. The spectrometer 20 is connected to the optical fiber F4 through the optical connector C5. The spectrometer 20 receives input of a reflected light L2 of the measurement object W through a probe 50, the optical fiber F3, the optical fiber F4 or the like.

The probe 50 includes a probe housing 52, a condenser lens 54, an objective lens 56, and an optical connector C4. The probe 50 receives input of the multi-wavelength light L1, which is emitted from the controller 11, from the optical connector C4 through the optical fiber F3.

The probe housing 52 supports the condenser lens 54 and the objective lens 56 in the inside of the probe housing 52. Here, illustration of the structure that supports the condenser lens 54 and the objective lens 56 is omitted. The optical connector C4 is attached at the end of the probe housing 52 that is opposite to the side where the objective lens 56 is supported. On the side of the condenser lens 54 closer to the optical connector C4, a dimming member 57 is arranged to block a part of the multi-wavelength light L1 incident on the condenser lens 54. Further details of the dimming member 57 are described later.

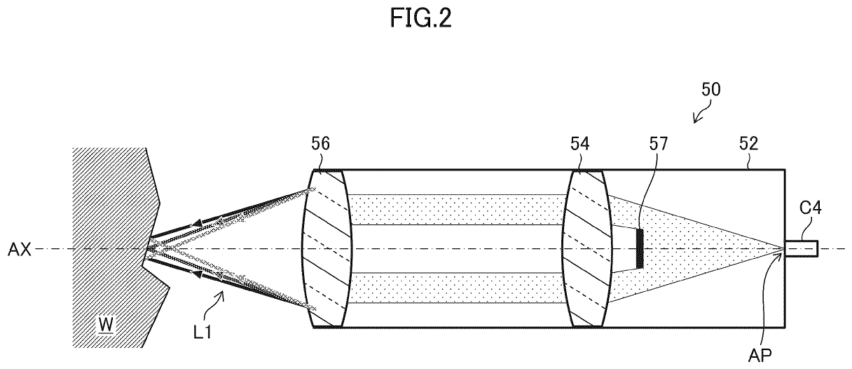

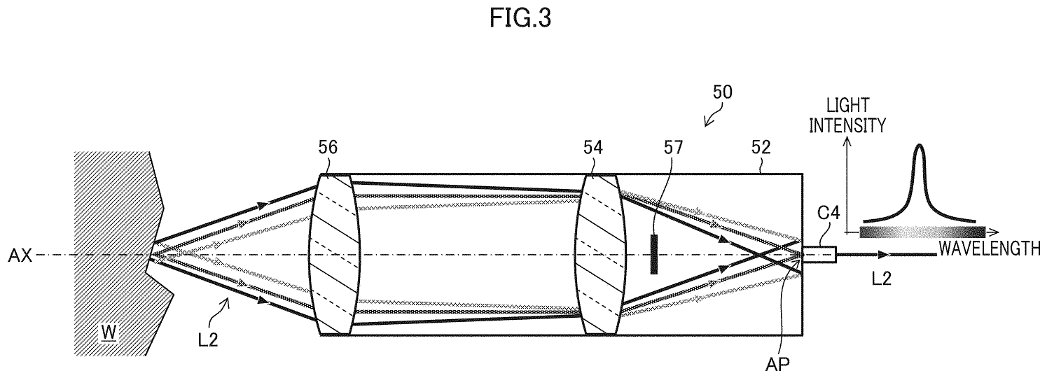

FIG. 2 is a schematic diagram of optical paths of incident light. FIG. 3 is a schematic diagram of optical paths of reflected light. FIG. 3 illustrates the distribution of light intensity of a reflected light L2 condensed to an aperture AP. The condenser lens 54 guides the multi-wavelength light L1 to be incident on the objective lens 56, and guides the reflected light L2 returned from the measurement object W to be incident on the aperture AP again. The condenser lens 54 may have a function to change the beam size of the multi-wavelength light L1 or may have a collimating function. The condenser lens 54 in the present embodiment functions as an achromatic lens and also functions as a collimator lens.

The objective lens 56 causes the multi-wavelength light L1 to have chromatic aberration along the optical axis AX of the multi-wavelength light L1, and condenses the multi-wavelength light L1 caused to have chromatic aberration to the measurement position of the measurement object W. In other words, the probe 50 irradiates spot light of the multi-wavelength light L1 to the measurement position of the measurement object W. The function of causing chromatic aberration can be achieved by using known members such as refractive lenses and diffraction lenses, as well as lenses where chromatic aberration is intentionally left. In FIGS. 1 to 3, a single lens having a function of causing chromatic aberration and a light condensing function is illustrated as the objective lens 56, though the objective lens 56 may be configured as a lens group including lenses corresponding to respective functions. For example, a first lens that causes chromatic aberration along the optical axis of the multi-wavelength light L1, and a second lens that condenses the multi-wavelength light L1 to the measurement object W. Here, the objective lens 56 described in the embodiment is an example of the first optical unit and also an example of the second optical unit.

Back to FIG. 1, the reflected light L2 which has returned from the measurement object W is input to the controller 11 through the aperture AP, the optical connector C4, the optical fiber F3, and the optical connector C3. The reflected light L2 input to the controller 11 is input to the spectrometer 20 through the optical fiber F2, the optical splitter C2, the optical fiber F4, and the optical connector C5.

The spectrometer 20 includes a spectroscopic element 22 and a photodetector 24. The spectroscopic element 22 separates the reflected light L2, which is input to the spectrometer 20, into single-wavelength components (monochromatic components). Light with a single-wavelength component can be referred to as monochromatic light. FIG. 1 illustrates a diffraction grating of a reflective type as the spectroscopic element 22, though the spectroscopic element 22 may be a transmission-type diffraction grating, or a prism. Here, the spectroscopic element 22 described in the embodiment is an example of the light receiver unit that acquires the spectral information of the multi-wavelength light that has passed through the aperture portion.

The photodetector 24 detects the wavelength at which the light intensity is maximum. In other words, the photodetector 24 is an optical element that detects the reflected light L2 dispersed into monochromatic lights. Examples of the photodetector 24 may include CCD image sensors and CMOS image sensors. Here, CCD is an abbreviation for Charge Coupled Device. CMOS is an abbreviation for Complementary Metal Oxide Semiconductor. Note that the wavelength of the light incident on the photodetector 24 shown in FIG. 1 becomes shorter toward the lower left and longer toward the upper right.

The probe 50 includes the dimming member 57. The dimming member 57 is arranged on the optical path of the multi-wavelength light L1 that is an incident light. The dimming member 57 is a dimming member that blocks a part of the multi-wavelength light L1 that is incident on the probe 50 through the optical connector C4 and then incident on the condenser lens 54. The dimming member 57 is supported using a support structure, although the illustration thereof is omitted.

For the photodetector 24 shown in FIG. 1, a line sensor in which pixels are one-dimensionally arranged along an irradiation direction of the lights dispersed using the spectroscopic element 22 is applied. The monochromatic lights dispersed by the spectroscopic element 22 are reflected at different angles depending on their wavelength and are input into respective pixels of the photodetector 24.

As the photodetector 24, an area sensor in which pixels are arranged in two dimensions may be used instead of the line sensor. In the case of obtaining the light intensity of each monochromatic light with the area sensor, pixel values of the pixels aligned in the direction perpendicular to a dispersing direction of the reflected light L2 may be added.

The graph shown in FIG. 1 is an example of the output signal of the photodetector 24. A horizontal axis of the graph in FIG. 1 represents the wavelength of the reflected light L2, and a vertical axis represents the light intensity, so that the graph shown in FIG. 1 shows the light intensity for each wavelength of the reflected light L2. The horizontal axis is regarded as the position of pixels of the line sensor. The light intensity is regarded as a pixel value of each pixel of the line sensor.

In readout signal processing in the photodetector 24 shown in FIG. 1, the pixel with maximum light intensity is identified and the wavelength of the reflected light L2 corresponding to the identified pixel is specified. The wavelength corresponding to the maximum light intensity is converted into a distance and is calculated as a distance from the probe 50 to the measurement position of the measurement object W. When the distance from the probe 50 to a reference position of the measurement object W is known, a displacement from the reference position to the measurement position of the measurement object W can be calculated. In this way, high-accuracy measurement of the measurement object W is implemented in non-contact measurement.

### [Detailed Description of Color Confocal Method]

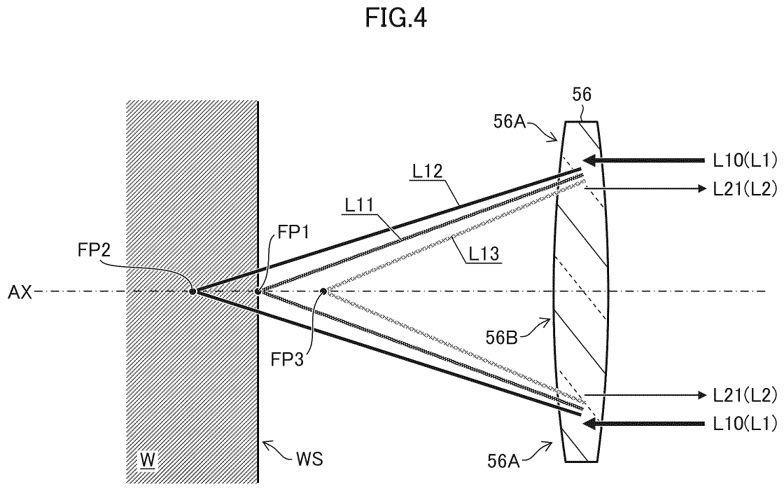

FIG. 4 is an explanatory diagram of the color confocal method and is also an explanatory diagram regarding the generation of chromatic aberration. In the multi-wavelength light L1, the multi-wavelength light L10 which has passed through a peripheral portion 56A of the objective lens 56, has a relatively large chromatic aberration, and the focal position of the multi-wavelength light L10 varies along the optical axis AX depending on the wavelength. Here, the peripheral portion 56A of the objective lens 56 is an area of the objective lens 56 not including the position of the optical axis AX of the objective lens 56 on the surface of the objective lens 56 on which light is incident or from which light exits. The optical axis AX of the objective lens 56 coincides with the optical axis AX of the multi-wavelength light L1.

For example, peripheral portion 56A of the objective lens 56 may be defined as a region located outside an area having a diameter equal to 20% of the diameter of the objective lens 56, centered on the position of the optical axis AX, on the surface of the objective lens 56 on which light is incident or from which light exits.

The area having a diameter equal to 20% of the diameter of the objective lens 56 centered on the position of the optical axis AX on the surface of the objective lens 56 on which light is incident or from which light exits may be specified as a center portion 56B of the objective lens 56. In the probe 50 shown in FIG. 1, the reflected light L2 from the measurement object W is collimated light between the objective lens 56 and the condenser lens 54. Therefore, the definition of the peripheral portion 56A of the objective lens 56 can also be applied to define the peripheral portion of the condenser lens 54. Similarly, the definition of the center portion 56B of the objective lens 56 can be applied to define the center portion of the condenser lens 54. Specifically, the peripheral portion of the condenser lens 54 may be defined as a region of the condenser lens 54 that is on the periphery of an area having a diameter equal to 20% of the diameter of the condenser lens 54 centered on the position of the optical axis AX on the surface of the condenser lens 54 on which light is incident or from which light exits. The area having a diameter equal to 20% of the diameter of the condenser lens 54 centered on the position of the optical axis AX on the surface of the condenser lens 54 on which light is incident or from which light exits may be defined as a center portion of the condenser lens 54.

FIG. 4 illustrates an incident light L11 that focuses on a surface WS of the measurement object W, and an incident light L12 and an incident light L13 that do not focus on the surface WS of the measurement object W. The surface WS of the measurement object W herein refers to the surface of the measurement object W that faces an exit surface of the probe 50.

FIG. 4 illustrates a focus position FP1 on the optical axis AX of the incident light L11, a focus position FP2 on the optical axis AX of the incident light L12, and a focus position FP3 on the optical axis AX of the incident light L13. FIG. 4 illustrates a reflected light L21, which is part of the reflected light L2 reflected at the focus position FP1 and passes through the peripheral portion 56A of the objective lens 56. The illustration of the reflected light L2 passing through the center portion or the like of the objective lens 56 is omitted.

In the reflected light L2, the reflected light L21 reflected at the focus position FP1 on the surface WS of the measurement object W is focused on the aperture AP of the optical fiber F4 shown in FIG. 1 and so on. Accordingly, most portions of the reflected light L21 are directed to the optical fiber F4.

Specifically, the focus position FP1 on the surface WS of the measurement object W and the position of the aperture AP of the optical fiber F4 are optically in a conjugate relationship, and therefore the aperture AP of the optical fiber F4 functions as a spatial filter or a pinhole that selectively passes the reflected light corresponding to the focused incident light on the surface WS of the measurement object W.

On the other hand, the reflected light L2 that does not focus on the surface WS of the measurement object W does not focus on the aperture AP of the optical fiber F4. In other words, the reflected light L2 that does not focus on the surface WS of the measurement object W is diffused in the vicinity of the aperture AP of the optical fiber F4. As a result, the reflected light L2 that does not focus on the surface WS of the measurement object W causes deterioration of the light guiding efficiency at the time of passing the optical fiber F4 as compared with the reflected light L21 that focuses on the surface WS of the measurement object W.

Therefore, in the reflected light L2, the reflected light L21 corresponding to the incident light L11 focused on the focus position FP1 on the surface WS of the measurement object W is higher in light intensity than the reflected light L2 corresponding to the incident light L12 that does not focus at the focus position FP1 on the surface WS of the measurement object W. Here, the reflected light L21 described in the embodiment is an example of the first reflected light. The reflected light L2 that does not focus on the surface WS of the measurement object W described in the embodiment is an example of the second reflected light. The aperture AP described in the embodiment is an example of the aperture portion that allows passing of at least part of the multi-wavelength light that has passed through the dimming member.

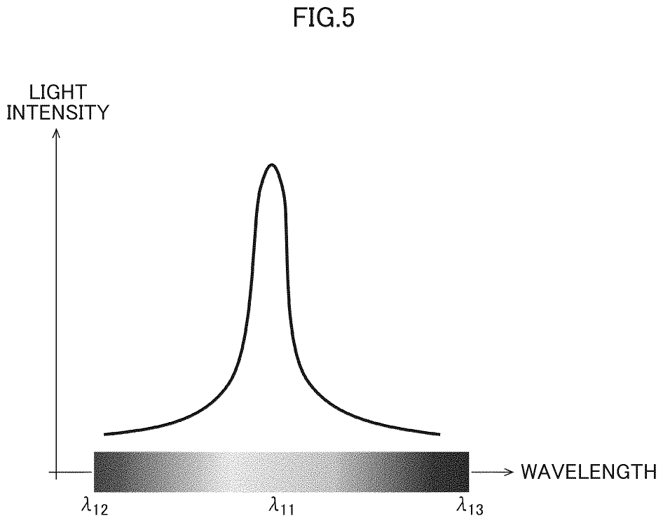

FIG. 5 is a schematic diagram showing an output signal of the spectrometer corresponding to the reflected light that has passed through the peripheral portion of the objective lens. FIG. 5 illustrates an output signal of the spectrometer 20 shown in FIG. 1 using a graph format. A horizontal axis of the graph shown in FIG. 5 represents the wavelength and a vertical axis represents the light intensity. In the horizontal axis of the graph in FIG. 5, the wavelength is longer toward the left and the wavelength is shorter toward the right. The same applies to the graphs shown in FIGS. 3, 7, and 8.

A wavelength λ11 shown in FIG. 5 represents the wavelength of the reflected light L21. Wavelengths λ12 and λ13 respectively represent the wavelength of the reflected light L2 corresponding to the incident light L12 and the wavelength of the reflected light L2 corresponding to the incident light L13. The reflected light L21 with the wavelength λ11 has a maximum output signal value representing the light intensity.

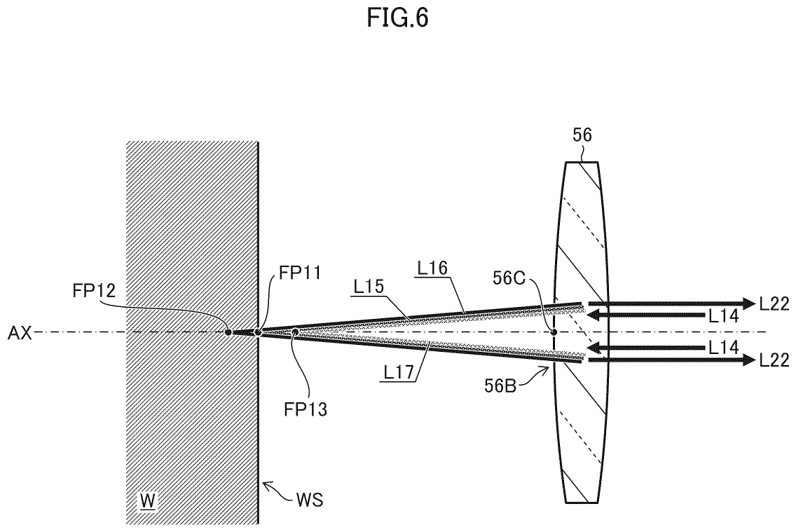

FIG. 6 is an explanatory diagram regarding the issues of the color confocal method and is also a schematic diagram of the light that has passed through a center portion of the objective lens. In a multi-wavelength light L14 incident on the center portion 56B of the objective lens 56, an incident light L15 focuses on a focus position FP11 on the surface WS of the measurement object W. On the other hand, an incident light L16 and an incident light L17 in the multi-wavelength light L14 focus on a focus position FP12 and a focus position FP13, respectively, which are not on the surface WS of the measurement object W.

Chromatic aberration is generated in the multi-wavelength light L14 incident on the center portion 56B of the objective lens 56, though the generated chromatic aberration is smaller than chromatic aberration generated in the multi-wavelength light L10 or the like incident on the peripheral portion 56A of the objective lens 56 shown in FIG. 4.

Theoretically, chromatic aberration is not generated at a center 56C of the objective lens 56 where the optical axis AX of the incident light L15 or the like passes. In other words, all the wavelengths of the reflected light L2 passing through the center 56C of the objective lens 56 are guided to the spectrometer 20 regardless of the position of the measurement object W. Note that reference numeral L22 represents the reflected light of the multi-wavelength light L14 incident on the center portion 56B of the objective lens 56.

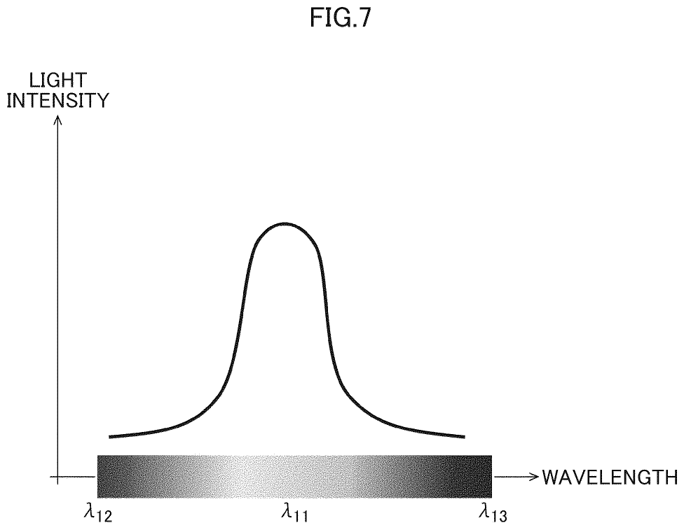

FIG. 7 is a schematic diagram showing an output signal of the spectrometer corresponding to the reflected light that has passed through the center portion of the lens. FIG. 7 illustrates an output signal of the spectrometer 20 shown in FIG. 1 using a graph format. A horizontal axis of the graph shown in FIG. 7 represents the wavelength and a vertical axis represents the light intensity. The curve representing the optical intensity shown in FIG. 7 has a broader wavelength band corresponding to the peak compared to the curve representing the optical intensity shown in FIG. 5.

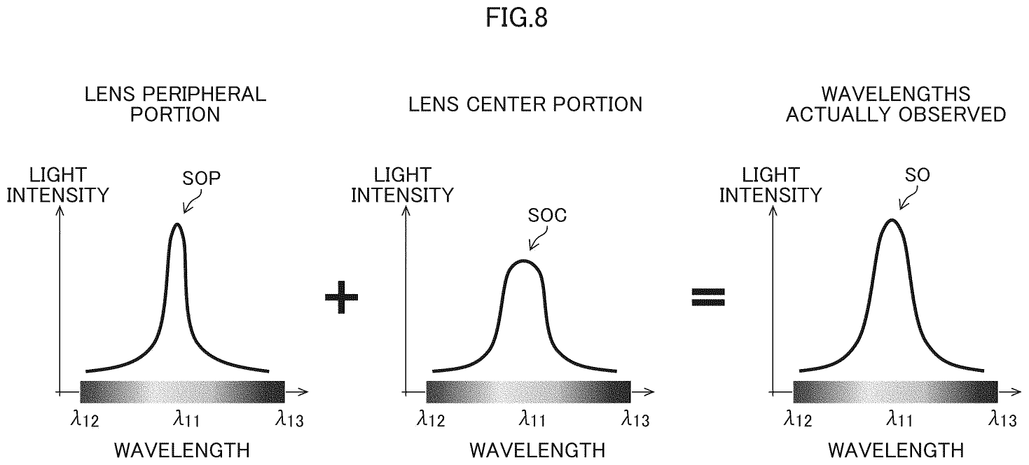

FIG. 8 is a schematic diagram of output signals actually observed. A signal SO actually output from the spectrometer 20 is formed by superimposing an output signal SOC of the spectrometer corresponding to the reflected light passing through the center portion 56B of the objective lens 56 on an output signal SOP of the spectrometer corresponding to the reflected light that has passed through the peripheral portion 56A of the objective lens 56.

In other words, the signal SO actually output from the spectrometer 20 has a broader wavelength band at the peak of light intensity compared to the output signal SOP of the spectrometer corresponding to the reflected light passing through the peripheral portion 56A of the objective lens 56. The relatively widened wavelength band of the light intensity peak affects the detection accuracy of the light intensity peak at the time of calculating the wavelength of the reflected light L2, which can lead to a deterioration in measurement resolution.

Accordingly, in the measurement device 10 according to the embodiment, the probe 50 includes the dimming member 57, and the dimming member 57 is adjusted. In the multi-wavelength light L1 input to the probe 50, at least a portion of the multi-wavelength light L1 passing through the center portion of the condenser lens 54 shown in FIG. 1 or the like is dimmed, and as a result, the multi-wavelength light L14 passing through the center portion 56B of the objective lens 56 shown in FIG. 6 is dimmed. At least a portion of the multi-wavelength light L1 passing through the center portion 56B of the objective lens 56 does not reach the measurement position of the measurement object W, so that at least part of the reflected light L22 passing through the center portion 56B of the objective lens 56 shown in FIG. 6 is dimmed and at least part of the reflected light L22 passing through the center portion of the condenser lens 54 is dimmed. As a result, in the measurement device 10 according to the embodiment, the amount of unnecessary light in the reflected light L2 guided to the spectrometer 20 is suppressed, while a decrease in the amount of necessary light is minimized. Consequently, the detection accuracy of the specified light intensity is ensured, which leads to securing the specified measurement accuracy.

### [Configuration Example of Probe Applied to Measurement Device According to First Embodiment]

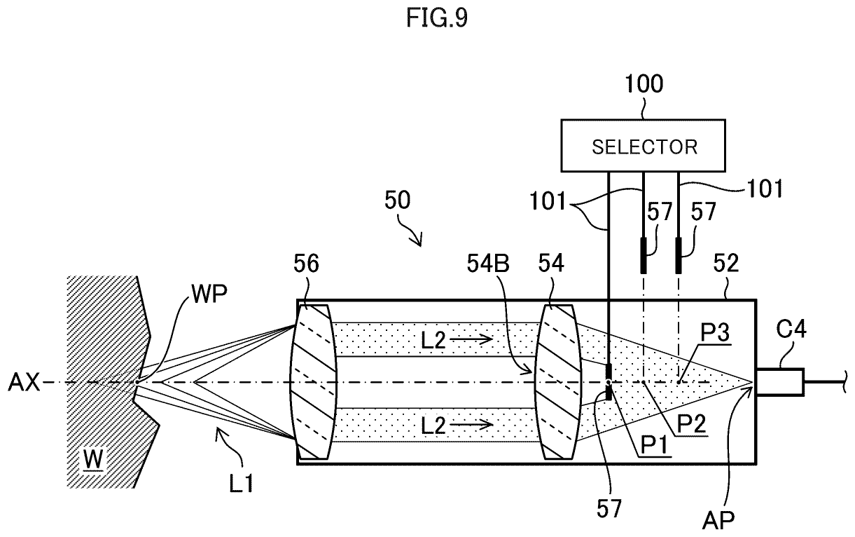

FIG. 9 is a schematic diagram showing a configuration example of the probe to be applied to the measurement device according to the first embodiment. The probe 50 shown in FIG. 9 is configured such that the dimming member 57 may be freely positioned at any location on the optical path of the multi-wavelength light L1, whose beam diameter is variable. FIG. 9 schematically illustrates a selector 100 that supports the dimming member 57 and selectively changes the position of the dimming member 57.

The selector 100 includes support members 101 that support two or more dimming members 57, and selector members that selectively arrange the respective dimming members 57 at a dimming position P61, a dimming position P2, and a dimming position P3, which are different from each other in the direction parallel to the optical axis AX. FIG. 9 illustrates the probe 50, which includes three dimming members 57, and one of the three dimming member 57 is arranged on the optical path of the multi-wavelength light L1.

This makes it possible to provide the same effect as changing the size of the dimming member 57 arranged on the optical path of the multi-wavelength light L1. For example, when the dimming member 57 is arranged at the dimming position P1, an area ratio of the area covered by the dimming member 57 to the cross-sectional area of the multi-wavelength light L1 at the position where the dimming member 57 is arranged, is smaller than the area ratio when the dimming member 57 is arranged at the dimming position P2 or. As a result, the light amount of the reflected light L2 reaching the aperture AP of the optical fiber F4 becomes relatively larger. Note that the cross-sectional area of the multi-wavelength light L1 refers to the cross-sectional area of the multi-wavelength light L1 on the plane perpendicular to the optical axis of the multi-wavelength light L1.

Similarly, when the dimming member 57 is arranged at the dimming position P2, an area ratio of the area covered by the dimming member 57 to the cross-sectional area of the multi-wavelength light L1 at the position where the dimming member 57 is arranged, is smaller than the area ratio when the dimming member 57 is arranged at the dimming position P3. As a result, the light amount of the reflected light L2 reaching the aperture AP of the optical fiber F4 becomes relatively larger. In other words, when the dimming member 57 is arranged at a position relatively close to the condenser lens 54, the light amount of the reflected light L2 reaching the aperture AP of the optical fiber F4 becomes relatively larger. On the other hand, when the dimming member 57 is arranged at a position relatively far from the condenser lens 54, the light amount of the reflected light L2 reaching the aperture AP of the optical fiber F4 becomes relatively smaller. Meanwhile, regardless of which position, among the dimming position P1, the dimming position P2, and the dimming position P3, the dimming member 57 is arranged, the reflected light L2 passing through a center portion 54B of the condenser lens 54 is suppressed from reaching the aperture AP of the optical fiber F4.

FIG. 9 illustrates an example of the selector 100, which inserts the dimming members 57 supported from the outside of the probe 50 into the probe 50, though the selector 100 may be included inside the probe 50.

Note that the selector 100 described in the embodiment is an example of a component member of the dimming adjustment unit that varies the area ratio, where the area ratio is defined as the ratio of the area of the multi-wavelength light blocked by the dimming member to the cross-sectional area of the multi-wavelength light at the position where the dimming member is arranged, and also an example of a component member of the position adjustment unit that adjusts the position of the dimming member in the direction parallel to the optical axis. The selector 100 described in the embodiment is also an example of a component member of the selection unit that selects the dimming member arranged at the position where the multi-wavelength light is blocked.

### [Electrical Configuration Example of Measurement Device According to First Embodiment]

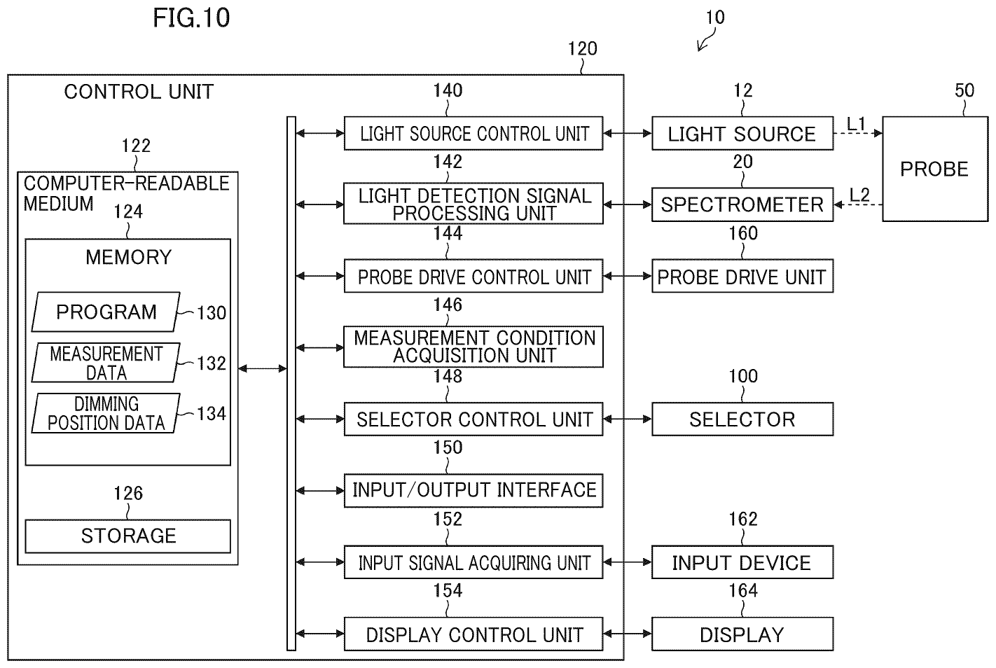

FIG. 10 is a functional block diagram showing an electrical configuration of the measurement device according to the first embodiment. For a control unit 120 of the measurement device 10, a computer is applied. The computer may be a personal computer, a workstation, or a tablet terminal. The computer may be a virtual machine.

The control unit 120 includes one or more computer-readable media 122 which are non-transitory tangible objects. The computer-readable medium 122 includes a memory 124 that functions as a main storage device, and a storage 126 that functions as an auxiliary storage device.

For the computer-readable medium 122, a semiconductor memory, a hard disk device, a solid-state drive device, or the like, is applicable. For the computer-readable medium 122, any combination of devices is applicable.

Here, the hard disk drive can be referred to as HDD, which is an abbreviation for Hard Disk Drive in English. The solid-state drive device can be referred to as SSD, which is an abbreviation for Solid-State Drive in English.

The memory 124 of the computer-readable medium 122 stores a program 130, measurement data 132, and dimming position data 134. The computer-readable medium 122 may include a device storing the program 130, a device storing the measurement data 132, and a device storing the dimming position data 134.

The program 130 includes various programs that implement various functions of the measurement device 10. The measurement data 132 includes measurement data of the measurement object W acquired when the measurement object W shown in FIG. 1 is measured. The measurement data may include coordinate values of each measurement position of the measurement object W. The dimming position data 134 includes the position of the dimming member 57 in the direction along the optical axis AX. The position of the dimming member 57 in the direction along the optical axis AX is stored in association with measurement conditions.

The control unit 120 includes a light source control unit 140. The light source control unit 140 executes a light source control program to implement a function of operation control of the light source 12. The operation control of the light source 12 includes on-off control of the light source 12, control of the light amount emitted from the light source 12, or the like.

The control unit 120 includes a light detection signal processing unit 142. The light detection signal processing unit 142 executes a light detection signal processing program to implement a light detection signal processing function. The light detection signal processing includes deriving a peak wavelength with a highest light intensity from a light detection signal acquired from the spectrometer 20, and deriving based on the peak wavelength a measurement value for each measurement position of the measurement object W. The light detection signal processing unit 142 stores the measurement value for each measurement position of the measurement object W in association with the measurement position in the memory 124 as the measurement data 132. Here, the light detection signal processing unit 142 described in the embodiment is an example of the signal processing unit that derives the measurement result of the measurement position of the measurement object based on the detection result of the spectrometer.

The control unit 120 includes a probe drive control unit 144. The probe drive control unit 144 executes a probe drive program to implement an operation control function of a probe drive unit 160. The probe drive unit 160 includes a support member that supports the probe 50 and a relative movement member that moves the probe 50 relative to the measurement object W.

The probe drive unit 160 may move the probe 50 relative to the fixed measurement object W, or may move the measurement object W relative to the fixed probe 50. The probe drive unit 160 may also move both the measurement object W and the probe 50.

The control unit 120 includes a measurement condition acquisition unit 146. The measurement condition acquisition unit 146 acquires measurement conditions of the measurement object W. Examples of the measurement conditions may include an item name of the measurement object W, a material of the measurement object W, a color of the measurement object W, a reflectivity of the measurement object W, and a type of surface treatment of the measurement object W.

The control unit 120 includes a selector control unit 148. The selector control unit 148 controls the operation of the selector 100. Specifically, the selector control unit 148 sets the position of the dimming member 57 by referring to the dimming position data 134 using the measurement conditions of the measurement object W as a parameter. The selector control unit 148 operates the selector 100 to select the dimming member 57 corresponding to the set position of the dimming member 57, and arranges the selected dimming member 57 at the specified position. Here, the selector control unit 148 is an example of a component member of the dimming adjustment unit and is also an example of a component member of the selection unit.

The control unit 120 includes an input/output interface 150. The input/output interface 150 implements data communication with external devices. Wireless communication or wired communication may be applied to the input/output interface 150. The input/output interface 150 may include different types of ports corresponding to standards different from each other. Examples of the standards applied to the input/output interface 150 may include USB (registered trademark). Here, USB is an abbreviation for Universal Serial Bus.

An input signal acquiring unit 152 acquires an input signal transmitted from an input device 162. The input device 162 includes a keyboard, a mouse, or the like. The input signal acquiring unit 152 acquires the information input by an operator operating the input device 162 as an input signal. The control unit 120 transmits command signals based on the input information acquired using the input signal acquiring unit 152 to various control units.

The control unit 120 includes a display control unit 154. The display control unit 154 transmits a display control signal to a display 164 and displays various information on the display 164. For the display 164, a touch panel system integrally configured with the input device 162 may be applied.

One or more processors are applied to various control units included in the control unit 120. The processor may be implemented as a CPU or as a dedicated device. Here, CPU is an abbreviation for Central Processing Unit. A single processing unit may be constituted of a single processor or may be constituted of two or more processors. Two or more processing units may be constituted using a single processor. For the processors, devices of the same type may be used, or devices of different types from each other may be used.

### [Procedure of Measurement Method According to First Embodiment]

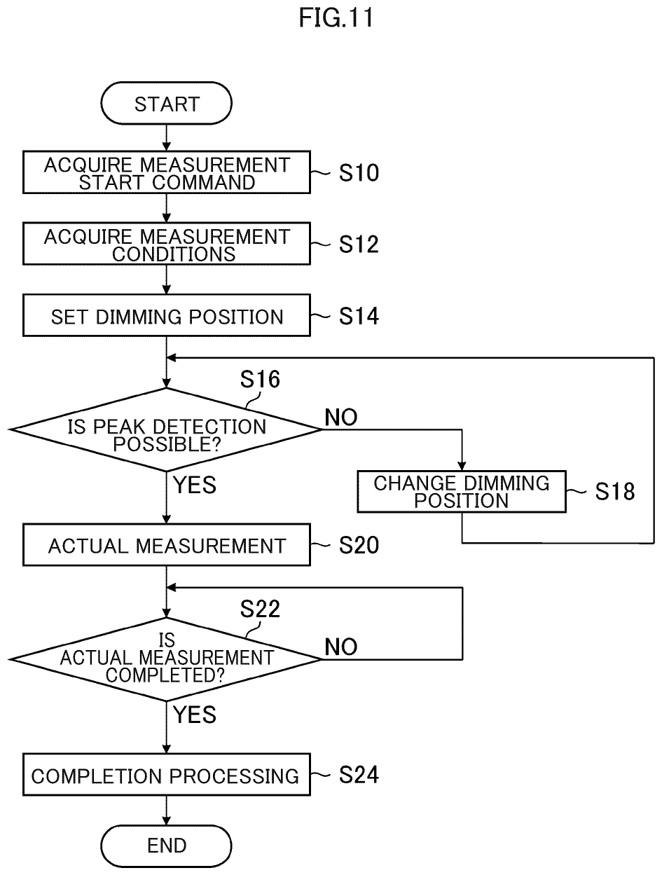

FIG. 11 is a flowchart showing a procedure of a measurement method according to the first embodiment. In measurement start command acquisition step S10, the control unit 120 shown in FIG. 10 acquires a measurement start command signal indicating the start of measurement of the measurement object W. Upon acquisition of the measurement start command signal, the control unit 120 starts measurement of the measurement object W shown in FIG. 1. After measurement start command acquisition step S10, the flow proceeds to measurement condition acquisition step S12.

In measurement condition acquisition step S12, the measurement condition acquisition unit 146 acquires measurement conditions such as the type of the measurement object W. The measurement conditions may be acquired from design information of the measurement object W, or information input by an operator using the input device 162 may be acquired. After measurement condition acquisition step S12, the flow proceeds to dimming position setting step S14.

In dimming position setting step S14, the selector control unit 148 determines the position of the dimming member 57 in the probe 50 based on the measurement conditions acquired in measurement condition acquisition step S12, and arranges the dimming member 57. After dimming position setting step S14, the flow proceeds to temporary measurement step S16.

In temporary measurement step S16, the control unit 120 controls the probe 50 to irradiate the multi-wavelength light L1 to a temporary measurement position of the measurement object W, which is prescribed in advance, and determines whether or not peak detection of the reflected light L2 is possible. When the control unit 120 determines that the peak detection of the reflected light L2 is difficult in temporary measurement step S16, “No” determination is made. When “No” determination is made, the flow proceeds to dimming position change step S18.

In dimming position change step S18, the selector control unit 148 changes the position of the dimming member 57 that is set in dimming position setting step S14. After dimming position change step S18, the flow proceeds to temporary measurement step S16, and temporary measurement step S16 and dimming position change step S18 are repeatedly executed until “Yes” determination is made in temporary measurement step S16. When the control unit 120 determines that peak detection is difficult at all the positions of the dimming member 57 in temporary measurement step S16, an error indicating this determination may be reported. The error may be reported by displaying an error message on the display 164, or by using sound such as voice and alarm sound.

Meanwhile, when the control unit 120 determines that the peak detection is possible in temporary measurement step S16, “Yes” determination is made. When “Yes” determination is made, the flow proceeds to actual measurement step S20.

In the actual measurement step S20, the control unit 120 performs actual measurement of the measurement object W. In the actual measurement, alignment between the measurement position specified for the measurement object W and the radiation position of the multi-wavelength light L1 irradiated from the probe 50 is performed, the reflected light L2 from the measurement object W is acquired, and measurement value at each measurement position is derived and acquired based on the peak detection result of the reflected light L2 at each measurement position. The acquired measurement values are stored in the memory 124 as measurement data 132 for each measurement position.

During execution of actual measurement step S20, actual measurement completion determination step S22 is performed. In actual measurement completion determination step S22, the control unit 120 determines whether or not measurement of the measurement object W is completed. When the measurement of the measurement object W is determined to be continued in actual measurement completion determination step S22, “No” determination is made. When “No” determination is made, the actual measurement completion determination step S22 continues.

Meanwhile, when the measurement of the measurement object W is determined to be completed in actual measurement completion determination step S22, “Yes” determination is made. When “Yes” determination is made, the flow proceeds to completion processing step S24, where specified completion step is performed, and the procedure of the measurement method is ended. Examples of the cases where the measurement of the measurement object W is completed may include the case where measurement values for all the specified measurement positions are obtained, and the case where the measurement of the measurement object W is forcibly terminated.

### Operational Effect of First Embodiment

The measurement device 10 and the measurement method according to the first embodiment can provide the following operational effects.

[1]

The probe 50 included in the measurement device 10 includes the dimming member 57 that is arranged between the condenser lens 54 and the aperture AP of the optical fiber F4 and that dims the multi-wavelength light L1 passing through the center portion 54B of the condenser lens 54. The position of the dimming member 57 in the direction along the optical axis AX is specified according to measurement conditions of the measurement object W including the type or the like of the measurement object W. As a result, the incidence on the spectrometer 20 of unnecessary reflected light L2, which is part of of the reflected light L2 of the multi-wavelength light L1 passing through the center portion 56B of the objective lens 56, is suppressed, and the light amount of the reflected light L2 required for peak detection is secured, thereby preventing deterioration in peak detection accuracy.

[2]

The measurement device 10 includes the selector 100 that sets one of dimming positions, such as the dimming position P1 in the direction along the optical axis AX according to the measurement conditions of the measurement object W, and arranges the dimming member 57 at the set dimming position such as the dimming position P1. As a result, automatic arrangement of the dimming member 57 according to the measurement conditions of the measurement object W is achieved.

[3]

In the measurement device 10, the dimming member 57 is set relatively closer to the condenser lens 54 in the case of relatively increasing the light amount of the reflected light L2 that reaches the aperture AP of the optical fiber F4. Meanwhile, in the measurement device 10, the dimming member 57 is set relatively far from the condenser lens 54 in the case of relatively decreasing the light amount of the reflected light L2 that reaches the aperture AP of the optical fiber F4. As a result, the light amount of the reflected light L2 input to the aperture AP of optical fiber F4 can be adjusted.

[4]

In the measurement device 10, the temporary measurement of the measurement object W is performed before actual measurement is performed in order to specify the dimming position of the dimming member 57, where peak detection of the preferable reflected light L2 is achieved. As a result, high-accuracy measurement according to the measurement conditions of the measurement object W is achieved.

### [Configuration Example of Probe Applied to Measurement Device According to Second Embodiment]

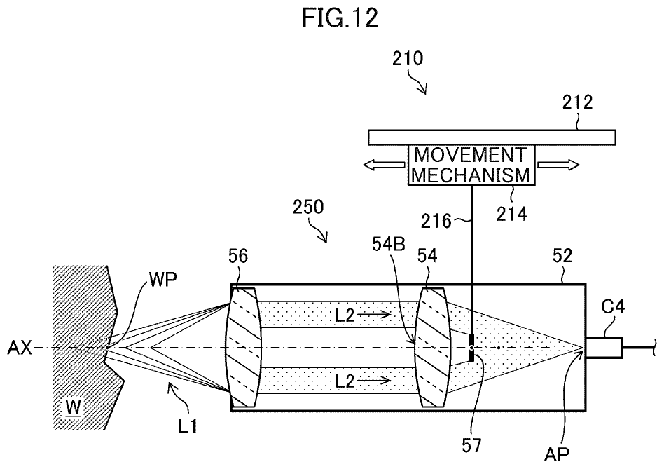

FIG. 12 is a schematic diagram showing a configuration example of a probe applied to a measurement device according to a second embodiment. In a probe 250 shown in FIG. 12, the position of the dimming member 57 is determined using a movement mechanism 210 shown in FIG. 12 instead of the selector 100 shown in FIG. 9. Specifically, the movement mechanism 210 includes a guide 212 extending in a direction parallel to the optical axis AX, a carriage 214 that moves along the guide 212, and a dimming support member 216 that supports the dimming member 57 on the carriage 214.

The movement mechanism 210 moves the dimming member 57 along the direction parallel to the optical axis AX and arranges the dimming member 57 at a specified dimming position. For the movement mechanism 210, a linear movement mechanism such as a ball screw and a linear slider is applied. Here, the movement mechanism 210 described in the embodiment is an example of the movement unit that moves the dimming member in the direction parallel to the optical axis.

### [Electrical Configuration Example of Measurement Device According to Second Embodiment]

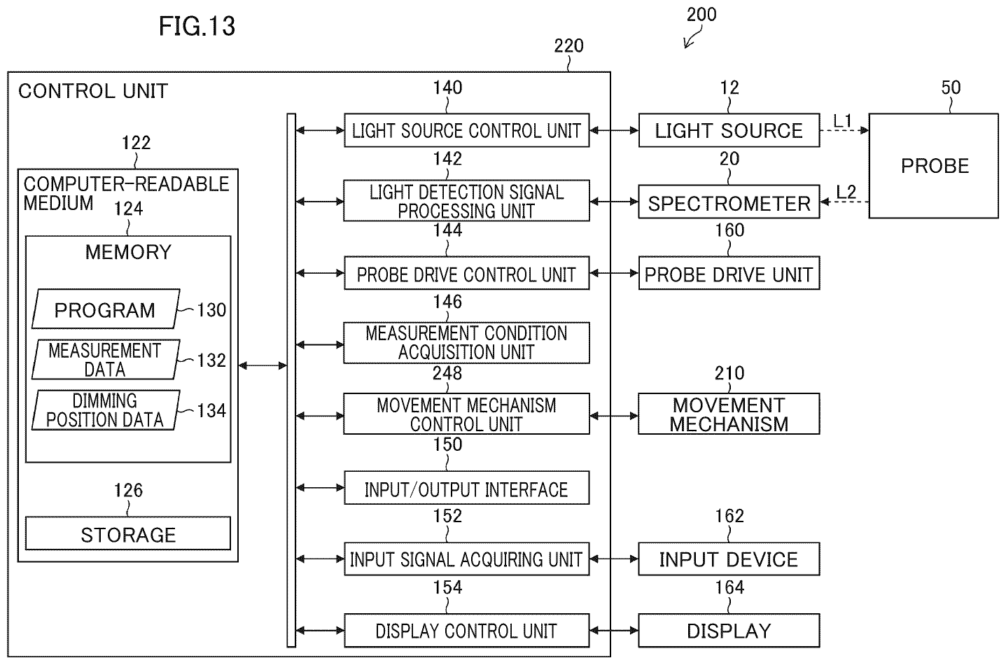

FIG. 13 is a functional block diagram showing an electrical configuration of the measurement device according to the second embodiment. A measurement device 200 shown in FIG. 13 includes a control unit 220 instead of the control unit 120 shown in FIG. 10. The control unit 220 shown in FIG. 13 includes a movement mechanism control unit 248 instead of the selector control unit 148 shown in FIG. 10.

The movement mechanism control unit 248 controls the operation of the movement mechanism 210 according to the measurement conditions of the measurement object W. Specifically, the movement mechanism control unit 248 sets the position of the dimming member 57 that is specified according to the measurement conditions of the measurement object W, and activates the movement mechanism 210 to move the dimming member 57 to the specified dimming position. A movement resolution of the movement mechanism 210 can be specified in accordance with the detection accuracy of the peak of the reflected light L2.

The movement mechanism control unit 248 can improve an SN ratio in peak detection by arranging the dimming member 57 at the position where dimming of the reflected light L2 is maximized within the range where the peak detection of the reflected light L2 is possible. For example, the movement mechanism control unit 248 arranges the dimming member 57 at a position where the reflected light L2 exceeding 50 percent of a maximum dynamic range value of the photodetector 24, can be obtained.

### [Procedure of Measurement Method According to Second Embodiment]

The procedure of the flowchart shown in FIG. 11 may be applied to a measurement method according to the second embodiment. In the measurement method according to the second embodiment, in actual measurement step S20, peak detection may be performed while changing the position of the dimming member 57. Specifically, instead of performing the temporary measurement, an optimal position of the dimming member 57 may be set in the actual measurement and measurement may be performed at each measurement position.

### Operational Effect of Second Embodiment

The measurement device 200 and the measurement method according to the second embodiment can provide the following operational effects.

[1]

The measurement device 200 includes the movement mechanism 210 that moves the dimming member 57 along the direction parallel to the optical axis AX between the condenser lens 54 and the aperture AP of the optical fiber F4. The measurement device 200 includes the movement mechanism control unit 248 that controls the operation of the movement mechanism 210 according to the measurement conditions of the measurement object W. This makes it possible to obtain the operational effect as in the first embodiment.

[2]

In the measurement device 200, the degree of freedom in arrangement of the dimming member 57 can be enhanced as compared with the measurement device 10 shown in FIG. 1 and the like.

[3]

In measurement of the measurement object W, the measurement device 200 can perform peak detection of the reflected light L2 by changing the dimming position where the dimming member 57 is arranged. As a result, an optimal dimming position of the dimming member 57 can be adjusted for each measurement position of the measurement object W.

### [Modification in Arrangement of Dimming Member]

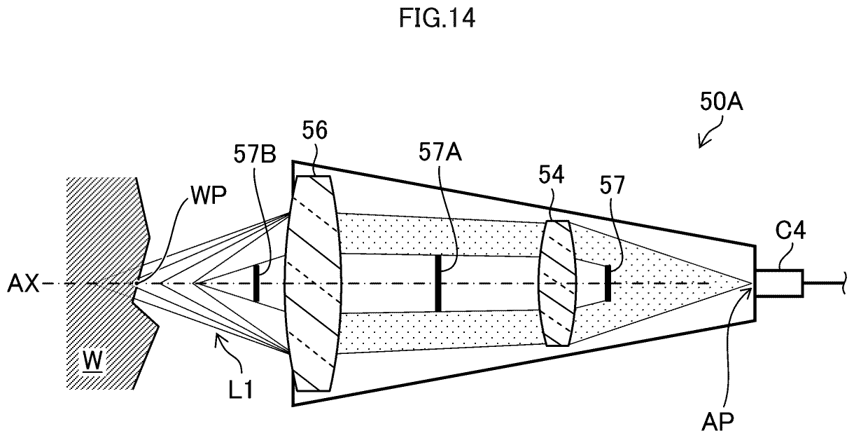

FIG. 14 is a schematic diagram showing a configuration example of a probe applied to a modification. FIG. 1 and the like illustrate the measurement device 10 in which the dimming member 57 is arranged between the condenser lens 54 and the aperture AP of the optical fiber F4; however, the arrangement of the dimming member 57 is not limited to this.

For example, as shown in FIG. 14, a dimming member 57A may be arranged between the objective lens 56 and the condenser lens 54 in a probe 50A. A dimming member 57B may be arranged between the measurement object W and the objective lens 56 in the probe 50A. In other words, the arrangement of the dimming member 57 is not limited as long as the dimming member 57 can block the multi-wavelength light L1 passing through the center portion 56B of the objective lens 56 and change the beam diameter of the multi-wavelength light L1 that has passed the condenser lens 54.

### [Configuration Example of Dimming Member]

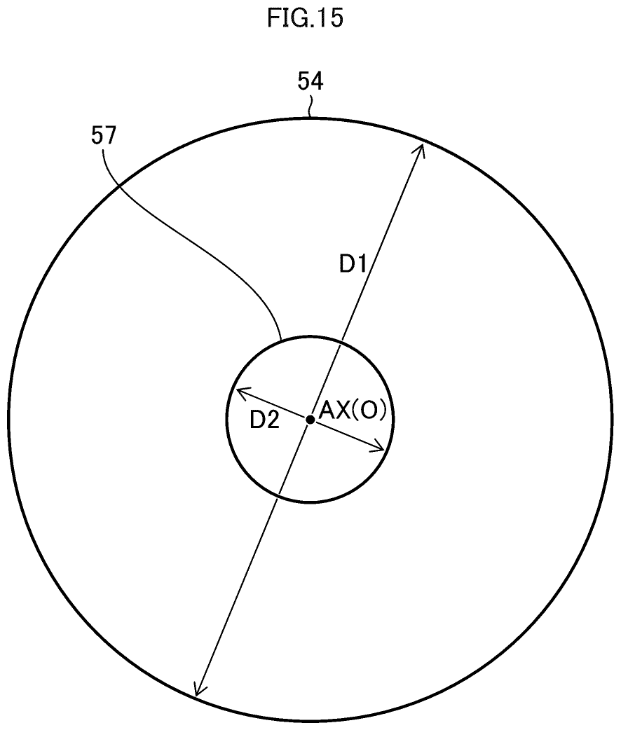

FIG. 15 is a front view of a dimming member showing an example of the size of the dimming member. FIG. 15 schematically illustrates the arrangement and size of the dimming member 57 relative to the condenser lens 54. Here, the direction perpendicular to FIG. 15 is the direction of the optical axis AX of the condenser lens 54.

FIG. 15 illustrates the dimming member 57 having a diameter D2 that is 20% of the diameter D1 of the condenser lens 54 and having a circular shape identical to a planar shape of the condenser lens 54. FIG. 15 also illuminates the dimming member 57 arranged at the position where the optical axis AX of the multi-wavelength light L1 passing through the center O.

The diameter D2 of the dimming member 57 may be less than 20 percent of the diameter D1 of the condenser lens 54. The minimum value of the diameter D2 of the dimming member 57 can be specified based on the strength of the dimming member 57 and handling of the dimming member 57. For example, the diameter D2 of the dimming member 57 may be adjusted in the range of 5% or more and less than 20% of the diameter D1 of the condenser lens 54.

The material of the dimming member 57 is not limited, as long as the material can dim the multi-wavelength light L1. For example, for the dimming member 57, materials such as resin and metal can be applied. In addition, the color of the dimming member 57 is not limited as long as the color can dim the reflected light L2. For example, colors such as black can be adopted for the dimming member 57.

The planar shape of the dimming member 57 is not limited to a circle. For the planar shape of the dimming member 57, various shapes can be adopted, such as ellipses, rectangles, and composite shapes combining semicircles and rectangles. The thickness of the dimming member 57 is not particularly limited as long as the reflected light L2 can be dimmed. The thickness of the dimming member 57 can be specified in accordance with the total length of a region in the direction along the optical axis AX where the dimming member 57 is arranged.

### [Configuration Example of Measurement Device According to Third Embodiment]

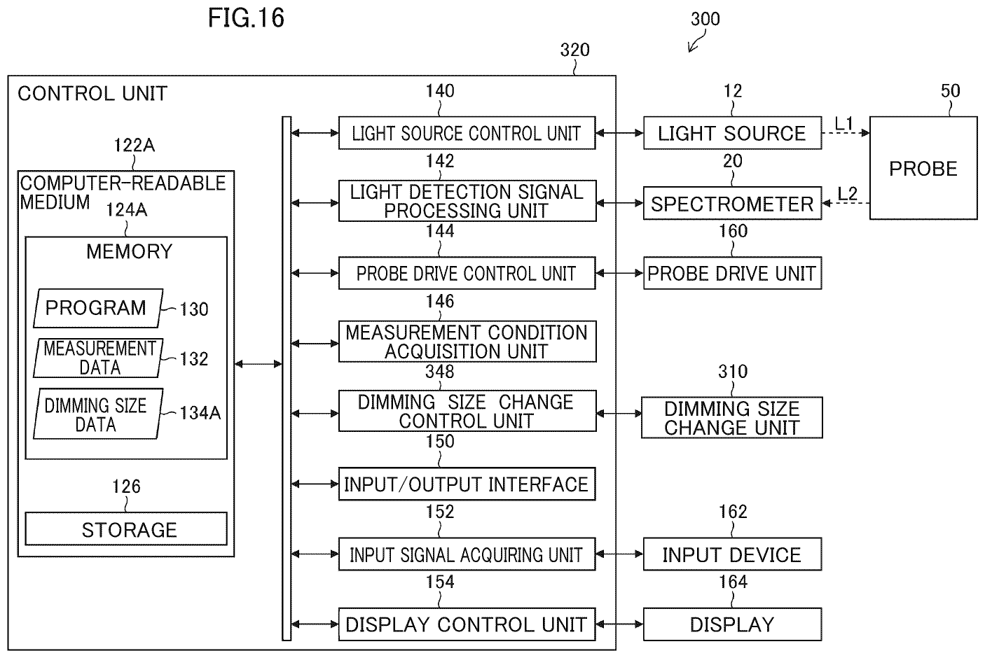

FIG. 16 is a functional block diagram showing an electrical configuration of a measurement device according to a third embodiment. A measurement device 300 according to the third embodiment includes a dimming size change unit 310 instead of the selector 100 included in the measurement device 10 shown in FIG. 10. The dimming size change unit 310 selectively switches the size of the dimming member 57 according to the measurement conditions of the measurement object W.

For example, the dimming size change unit 310 may employ a configuration in which only one dimming member 57, having a size specified according to the measurement conditions of the measurement object W, is selected from among the dimming members 57 of different sizes, and the selected dimming member 57 is arranged at the specified dimming position.

The measurement device 300 also includes a control unit 320 instead of the control unit 120 shown in FIG. 10. The control unit 320 includes a dimming size change control unit 348 instead of the selector control unit 148 shown in FIG. 10. A memory 124A included in a computer-readable medium 122A stores dimming size data 134A instead of the dimming position data 134 shown in FIG. 10 and the like.

The dimming size change control unit 348 refers to the dimming size data 134A stored in the memory 124A to select the size of the dimming member 57 according to the measurement conditions of the measurement object W, and controls the operation of the dimming size change unit 310.

Here, the dimming size change unit 310 described in the embodiment is an example of a component member of the size variable unit that varies the area of the dimming member which blocks the multi-wavelength light L1. In addition, the dimming size change control unit 348 described in the embodiment is an example of a component member of the size variable unit.

### [Procedure of Measurement Method According to Third Embodiment]

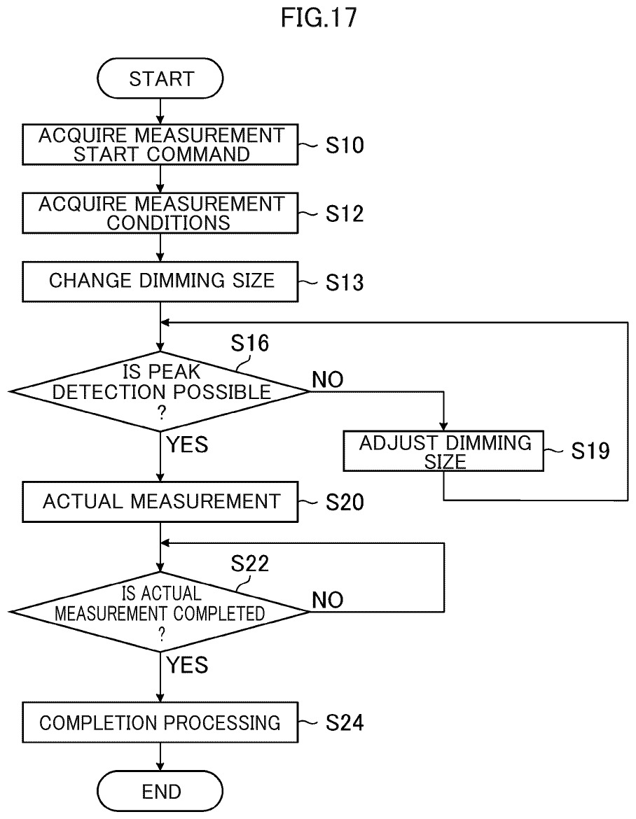

FIG. 17 is a flowchart showing a procedure of a measurement method according to the third embodiment. In the flowchart shown in FIG. 17, dimming size change step S13 is performed instead of dimming position setting step S14 shown in FIG. 11.

Specifically, when the measurement conditions of the measurement object W are acquired in measurement condition acquisition step S12, dimming size change step S13 is performed. In dimming size change step S13, the dimming member 57 having the size corresponding to the measurement conditions of the measurement object W acquired in measurement condition acquisition step S12 is selected, and the selected dimming member is arranged at the specified dimming position.

In the flowchart shown in FIG. 17, dimming size change step S19 is performed instead of dimming position change step S18 shown in FIG. 11. In dimming size adjustment step S19, the size adjustment of the dimming member 57 is performed when “No” determination is made in temporary measurement step S16. The size adjustment of the dimming member 57 is repeatedly performed until “Yes” determination is made in temporary measurement step S16.

Respective steps after actual measurement step S20 in the flowchart shown in FIG. 17 are similar to those in the flowchart shown in FIG. 11, and the description thereof is omitted here.

### Operational Effect of Third Embodiment

The measurement device 300 and the measurement method according to the third embodiment can achieve the following operational effects.

[1]

The size of the dimming member 57, which blocks a portion of the multi-wavelength light L1 passing through the center portion 54B of the condenser lens 54, is changed according to the measurement conditions of the measurement object W. As a result, the same operational effect as in the first embodiment can be obtained.

[2]

In the measurement device 300 and the measurement method according to the third embodiment, the size of the dimming member 57 that blocks a part of the multi-wavelength light L1 passing through the center portion 54B of the condenser lens 54 is changed without moving the dimming member 57 in the direction parallel to the optical axis AX.

In the above-described embodiments of the present invention, modifications, additions, and deletion of component members are possible as appropriate without departing from the spirit of the present invention. It is to be understood that there is no intention of limiting the present invention to the embodiments disclosed above, but the present invention is to cover many modifications made by a person with ordinary skill in the art within a technical idea of the present invention.

### REFERENCE SIGNS LIST

10 . . . measurement device, 11 . . . controller, 12 . . . light source, 14 . . . light guide member, 20 . . . spectrometer, 22 . . . spectroscopic element, 24 . . . photodetector, 50 . . . probe, 52 . . . probe housing, 54 . . . condenser lens, 54B . . . center portion, 56 . . . objective lens, 56A . . . peripheral portion, 56B . . . center portion, 57 . . . dimming member, 57A dimming member, 57B . . . dimming member, 100 . . . selector, 101 . . . support member, 120 . . . control unit, 122 . . . computer-readable medium, 122A . . . computer-readable medium, 124 . . . memory, 124A . . . memory, 126 . . . storage, 130 . . . program, 132 . . . measurement data, 134 . . . dimming position data, 134A . . . dimming size data, 140 . . . light source control unit, 142 . . . optical detection signal processing unit, 144 . . . probe drive control unit, 146 . . . measurement condition acquisition unit, 148 . . . selector control unit, 150 . . . input/output interface, 152 . . . input signal acquisition unit, 154 . . . display control unit, 160 . . . probe drive unit, 162 . . . input device, 164 . . . display, 200 . . . measurement device, 210 . . . movement mechanism, 212 . . . guide, 214 . . . carriage, 216 . . . dimming support member, 220 . . . control unit, 248 . . . movement mechanism control unit, 250 . . . probe, 300 . . . measurement device, 310 . . . dimming size change unit, 320 . . . control unit, 348 . . . dimming size change control unit, AP . . . aperture, AX . . . optical axis, C1 . . . optical connector, C2 . . . optical splitter, C3 . . . optical connector, C4 . . . optical connector, C5 . . . optical connector, F1 . . . optical fiber, F2 . . . optical fiber, F3 . . . optical fiber, F4 . . . optical fiber, FP1 . . . focus position, FP2 . . . focus position, FP3 . . . focus position, FP11 . . . focus position, FP12 . . . focus position, FP13 . . . focus position, L1 . . . multi-wavelength light, L2 . . . reflected light, L10 . . . multi-wavelength light, L11 . . . incident light, L12 . . . incident light, L13 . . . incident light, L14 . . . multi-wavelength light, L15 . . . incident light, L16 . . . incident light, L17 . . . incident light, L21 . . . reflected light, P1 . . . dimming position, P2 . . . dimming position, P3 . . . dimming position, SO . . . signal, SOC . . . output signal, SOP . . . output signal, W . . . measurement object, WP . . . measurement position, WS . . . surface, λ11 . . . Wavelength, λ12 . . . wavelength, λ13 . . . wavelength, S10 . . . measurement start command acquisition step, S12 . . . measurement condition acquisition step, S13 . . . dimming size change step, S14 dimming position setting step, S16 . . . temporary measurement step, S18 . . . dimming position change step, S19 . . . dimming size adjustment step, S20 . . . actual measurement step, S22 . . . actual measurement completion determination step, S24 . . . completion processing step

What is claimed is:

1. A measurement device, comprising:
a light source configured to emit multi-wavelength light containing a plurality of light components having wavelengths different from each other;
a first optical unit configured to introduce chromatic aberration along an optical axis into the multi-wavelength light emitted from the light source;
a second optical unit configured to focus the multi-wavelength light, into which the chromatic aberration has been introduced, onto a measurement position of a measurement object;
at least one dimming member configured to block a part of the multi-wavelength light incident on the first optical unit, the at least one dimming member arranged at a position intersecting the optical axis;
a dimming adjustment unit configured to vary an area ratio that is a ratio of an area of the multi-wavelength light blocked by the at least one dimming member to a cross-sectional area of the multi-wavelength light at the position where the at least one dimming member is arranged;
an aperture portion configured to allow at least a part of the multi-wavelength light that has passed through the at least one dimming member, to pass therethrough; and
a light receiver unit configured to acquire spectral information of the multi-wavelength light which has passed through the aperture portion.

2. The measurement device according to claim 1, wherein the dimming adjustment unit includes a position adjustment unit configured to adjust a position of the at least one dimming member in a direction parallel to the optical axis.

3. The measurement device according to claim 2, comprising
a plurality of dimming members, wherein
the position adjustment unit includes a selection unit configured to select the dimming member to be arranged at a position that blocks the multi-wavelength light, from among the plurality of dimming members supported at different positions from each other, along the direction parallel to the optical axis.

4. The measurement device according to claim 2, wherein
the position adjustment unit includes a movement unit configured to move the at least one dimming member in the direction parallel to the optical axis.

5. The measurement device according to claim 1, wherein
the at least one dimming member is arranged between the first optical unit or the second optical unit, and the aperture portion.

6. The measurement device according to claim 1, wherein
the dimming adjustment unit includes a size variable unit configured to vary the area of the at least one dimming member that blocks the multi-wavelength light.

7. The measurement device according to claim 1, comprising
a measurement condition acquisition unit configured to acquire a measurement condition in measuring the measurement object, wherein
depending on the acquired measurement condition, the dimming adjustment unit varies an area ratio that is a ratio of the area of the multi-wavelength light blocked by the at least one dimming member to the cross-sectional area of the multi-wavelength light at the position where the at least one dimming member is arranged.

8. The measurement device according to claim 1, comprising
a probe configured to irradiate the multi-wavelength light into which the chromatic aberration has been introduced, onto the measurement position of the measurement object, and to receive reflected light of the multi-wavelength light irradiated onto the measurement object, wherein
the probe includes
the first optical unit,
the second optical unit, and
the at least one dimming member.

9. The measurement device according to claim 1, wherein the first optical unit and the second optical unit are configured integrally.

10. A measurement method for measuring a surface of a measurement object by irradiating to the measurement object, multi-wavelength light which contains a plurality of light components having wavelengths different from each other and into which chromatic aberration is introduced along an optical axis, the measurement method comprising:
focusing the multi-wavelength light into which the chromatic aberration is introduced, onto a measurement position of the measurement object;
varying an area ratio, the area ration being a ratio of an area of the multi-wavelength light blocked by at least one dimming member to a cross-sectional area of the multi-wavelength light at a position where the at least one dimming member is arranged, wherein the at least one dimming member is arranged at a position intersecting the optical axis and blocks a part of the multi-wavelength light incident on a first optical unit that has introduced the chromatic aberration;
allowing at least a part of the multi-wavelength light that has passed through the at least one dimming member to pass through an aperture portion having a conjugate relationship with a focus position on the measurement object; and
acquiring spectral information of the multi-wavelength light which has passed through the aperture portion.
